(19) United States
(12) Patent Application Publication
(10) Pub. No.: US 2021/0409576 A1
(43) Pub. Date: Dec. 30, 2021

(54) DISPLAY CONTROL APPARATUS, DISPLAY APPARATUS, DISPLAY CONTROL SYSTEM, AND STORAGE MEDIUM

(71) Applicant: DENSO CORPORATION, Kariya-city (JP)

(72) Inventors: Toshitaka ASAI, Kariya-city (JP); Mitsuo TAMAGAKI, Kariya-city (JP); Yoshitaka ADACHI, Kariya-city (JP); Naoki YOKOTA, Kariya-city (JP); Ken AIDA, Kariya-city (JP); Satoshi KATANO, Kariya-city (JP)

(21) Appl. No.: 17/469,307

(22) Filed: Sep. 8, 2021

Related U.S. Application Data
(63) Continuation of application No. PCT/JP2020/006296, filed on Feb. 18, 2020.

(30) Foreign Application Priority Data
Mar. 13, 2019 (JP) 2019-045888

(51) Int. Cl. H04N 5/067; H04N 7/035; H04N 7/025; G06F 3/14

(52) U.S. Cl. CPC H04N 5/067; G06F 3/14; H04N 7/0255; H04N 7/035

(57) ABSTRACT

A display control apparatus is configured to synchronize a transmission start timing to start a transmission of a video data to a display apparatus with a display operation start timing for the display apparatus to start a display operation in a display.

### CROSS REFERENCE TO RELATED APPLICATIONS

The present application is a continuation application of International Patent Application No. PCT/JP2020/006296 filed on Feb. 18, 2020, which designated the U.S. and claims the benefit of priority from Japanese Patent Application No. 2019-045888 filed on Mar. 13, 2019. The entire disclosures of all of the above applications are incorporated herein by reference.

### TECHNICAL FIELD

The present disclosure relates to a display control apparatus, a display apparatus, a display control system, and a storage medium.

### BACKGROUND

There is known a display control system including (i) a display apparatus with a display and (ii) a display control apparatus for controlling a video displayed on the display in the display apparatus.

In this type of display control system, when video data is transmitted from the display control apparatus to the display apparatus, the video corresponding to the video data is displayed on the display apparatus. For example, if the display apparatus is an in-vehicle meter apparatus, video data is transmitted from the display control apparatus to the meter apparatus, so that, for example, videos such as the remaining amount of fuel and the mileage are displayed on the meter apparatus.

The display control apparatus and the display apparatus are different from each other in respect of the software configuration and hardware processing capacity. The activating time from when the display control apparatus starts the activating process to when the video data can be transmitted to the display apparatus is thus different from the activating time from when the display apparatus starts the activating process to when the video corresponding to the video data can be displayed.

### SUMMARY

According to an example of the present disclosure, a display control apparatus is provided as follows. The display control apparatus is configured to synchronize a transmission start timing to start a transmission of a video data to a display apparatus with a display operation start timing for the display apparatus to start a display operation in a display.

### BRIEF DESCRIPTION OF DRAWINGS

The objects, features and advantages of the present disclosure will become more apparent from the following detailed description made with reference to the accompanying drawings. In the drawings:

FIG. 1 is a functional block diagram showing an overall configuration of a first embodiment;

FIG. 2 is a diagram showing a meter apparatus;

FIG. 3 is a diagram showing a configuration of a controller of a display control ECU and a controller of a meter apparatus;

FIG. 4 is a diagram (No. 1) showing a sequence of a process when an activating factor occurs;

FIG. 5 is a diagram (No. 2) showing a sequence of a process when an activating factor occurs;

FIG. 6 is a diagram (No. 1) showing a sequence of a process when a sleep factor occurs;

FIG. 7 is a diagram (No. 2) showing a sequence of a process when a sleep factor occurs;

FIG. 8 is a diagram (No. 3) showing a sequence of a process when an activating factor occurs according to a second embodiment;

FIG. 9 is a diagram (No. 4) showing a sequence of a process when an activating factor occurs;

FIG. 10 is a diagram (No. 5) showing a sequence of a process when an activating factor occurs according to a third embodiment;

FIG. 11 is a diagram (No. 6) showing a sequence of a process when an activating factor occurs;

FIG. 12 is a diagram (No. 3) showing a sequence of a process when a sleep factor occurs according to a fourth embodiment; and

FIG. 13 is a diagram (No. 4) showing a sequence of a process when a sleep factor occurs.

### DETAILED DESCRIPTION

### First Embodiment

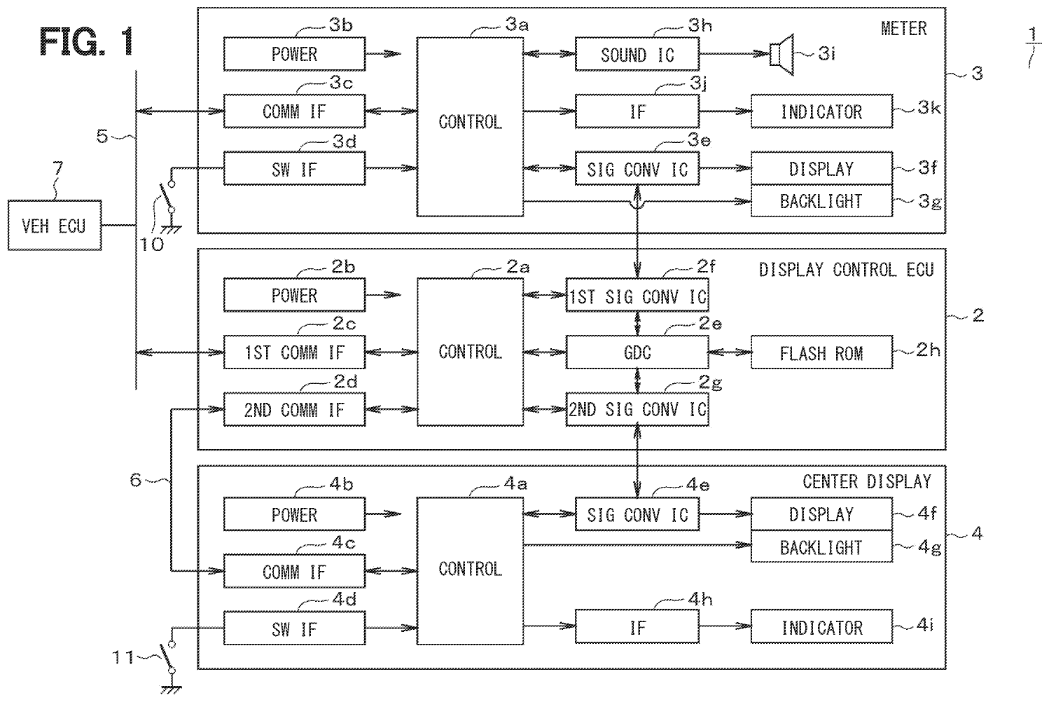

A first embodiment will be described with reference to FIGS. 1 to 7. As shown in FIG. 1, a display control system 1 includes (i) a display control ECU (Electronic control unit) 2 (i.e., display control apparatus), (ii) a meter apparatus 3 (i.e., display apparatus) arranged in front of the driver's seat, and (iii) a center display apparatus 4 (i.e., display apparatus) arranged on the center console between the driver's seat and the passenger seat. The display control ECU 2 includes an HMI (Human Machine Interface) function in addition to the display control function, and functions as an HCU (HMI control unit). The display control ECU 2 is connected to the meter apparatus 3 via the in-vehicle network 5 so as to be capable of data communication, and is also connected to the center display apparatus 4 via the data communication line 6 so as to be capable of data communication. Further, the display control ECU 2 and the meter apparatus 3 are connected to the vehicle side ECU 7 via the in-vehicle network 5 so as to be capable of data communication. The in-vehicle network 5 is, for example, CAN (Controller Area Network) (registered trademark) or the like.

The display control ECU 2 centrally controls the display of videos in the meter apparatus 3 and the center display apparatus 4 by transmitting video data to the meter apparatus 3 and the center display apparatus 4. By receiving the video data transmitted from the display control ECU 2, the meter apparatus 3 displays a video related to safety and security such as the remaining amount of fuel and the mileage.

By receiving the video data transmitted from the display control ECU 2, the center display apparatus 4 displays a video related to infotainment such as audio information and navigation information.

The present embodiment illustrates the configuration in which the display control ECU 2 centrally controls the display of videos on the two display apparatuses of the meter apparatus 3 and the center display apparatus 4. However, the display control ECU 2 may be configured to control the display of videos on one display apparatus, or may be configured to centrally control the display of videos on three or more display apparatuses. The display apparatus of which the display videos are controlled by the display control ECU 2 may be a head-up display apparatus, a multi-information display apparatus, a mobile device such as a smartphone or a tablet brought into the vehicle interior, or the like.

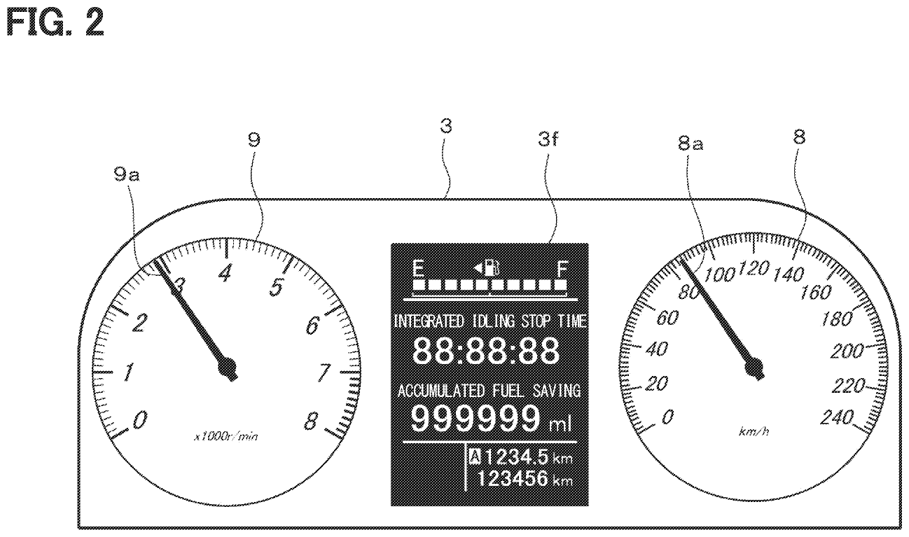

As shown in FIG. 2, the meter apparatus 3 includes (i) an analog pointer type vehicle speed meter 8 in which the pointer 8a is rotationally driven in conjunction with the vehicle speed, (ii) an analog pointer type tachometer 9 in which the pointer 9a is rotationally driven in conjunction with the engine speed, and (iii) a display 3f that displays various vehicle states. The display 3f is arranged between the vehicle speed meter 8 and the tachometer 9. In the state where the meter apparatus 3 is activated, the display 3f can display (i) the remaining amount of fuel, (ii) the integrated idling stop time, (iii) the accumulated fuel saving, (iv) the ODO distance (123456 km in the example of FIG. 2), and (v) the TRIP distance (1234.5 km in the example of FIG. 2), as videos. The meter apparatus 3 may have a configuration in which the vehicle speed and the number of rotations can be also displayed by videos, or may have a so-called full display configuration.

The display control ECU 2 includes (i) a controller 2a (which may also be referred to as a controller unit, a first controller, or a first controller unit), (ii) a power supply circuit 2b, (iii) a first communication IF unit 2c, (iv) a second communication IF unit 2d, (v) a GDC (Graphic Display Controller) 2e, (vi) a first signal conversion IC (Integrated Circuit) 2f (which may also be referred to as a video data transmitter, a video data transmitter unit, an activating request transmitter, or an activating request transmitter unit), (vii) a second signal conversion IC 2g (which may also be referred to as a video data transmitter, a video data transmitter unit, an video data transmitter, or a video data transmitter unit), and (viii) a flash ROM (Read Only Memory) 2h. Further, the first signal conversion IC 2f and the second signal conversion IC 2g may each function not only as a transmitter transmitting data but also as a receiver receiving data; namely the first signal conversion IC 2f and the second signal conversion IC 2g may each function as a transceiver communicating data.

The controller 2a is mainly composed of an MPU (Micro Processing Unit), executes a control program, and controls the overall operation of the display control ECU 2. The control program executed by the controller 2a includes a display control program. The power supply circuit 2b supplies operating power to each functional block inside the display control ECU 2. The first communication IF unit 2c controls data communication with the meter apparatus 3 via the in-vehicle network 5. The second communication IF unit 2d controls data communication with the center display apparatus 4 via the data communication line 6. The GDC 2e reads the data stored in the flash ROM 2h and processes the read data to generate video data (i.e., drawing data).

When the first signal conversion IC 2f receives video data from the GDC 2e, the first signal conversion IC 2f transmits the received video data to the meter apparatus 3 by LVDS (Low Voltage Differential Signaling) communication. When the second signal conversion IC 2g receives video data from the GDC 2e, the second signal conversion IC 2g transmits the received video data to the center display apparatus 4 by LVDS communication. LVDS communication includes GVIF (Gigabit Video Interface), GMSL (Gigabit Multimedia Serial Link), HDMI (High-Definition Multimedia Interface) (registered trademark), Ethernet (registered trademark), and the like.

The meter apparatus 3 includes (i) a controller 3a (which may also be referred to as a controller unit, a second controller, or a second controller unit), (ii) a power supply circuit 3b, (iii) a communication IF unit 3c, (iv) a switch IF unit 3d, (v) a signal conversion IC 3e (which may also be referred to as a video data receiver, a video data receiver unit, an activating request receiver, or an activating request receiver unit), (vi) a display 3f (display unit), (vii) a backlight 3g, (viii) a sound IC 3h, (ix) a speaker 3i, (x) an IF unit 3j, and (xi) an indicator 3k. Further, the signal conversion IC 3e may function not only as a receiver receiving data but also as a transmitter transmitting data; namely the signal conversion IC 3e may function as a transceiver communicating data.

The controller 3a is mainly composed of a MPU, executes a control program, and controls the overall operation of the meter apparatus 3. The control program executed by the controller 3a includes a display program. The power supply circuit 3b supplies operating power to each functional block inside the meter apparatus 3. The communication IF unit 3c controls data communication with the display control ECU 2 via the in-vehicle network 5. The switch IF unit 3d detects the on/off of the ODO/TRIP switch 10 and outputs the detection result to the controller 3a. When the signal conversion IC 3e receives the video data transmitted from the display control ECU 2, the signal conversion IC 3e converts the received video data in accordance with the standard of the meter apparatus 3 and outputs the converted video data to the display 3f.

The display 3f is, for example, a TFT (Thin-Film-Transistor) liquid crystal display; when video data is received from the signal conversion IC 3e, the received video data is decoded and the video corresponding to the video data is displayed. The backlight 3g is turned on when a lighting on command is received from the controller 3a, and is turned off when a lighting off command is received from the controller 3a. When the sound IC 3h receives a sound output command from the controller 3a, the sound IC 3h outputs the sound from the speaker 3i according to the received sound output command. When the IF unit 3j receives a display command from the controller 3a, the IF unit 3j displays the indicator 3k according to the received display command.

The center display apparatus 4 includes (i) a controller 4a (which may also be referred to as a controller unit, a second controller, or a second controller unit), (ii) a power supply circuit 4b, (iii) a communication IF unit 4c, (iv) a switch IF unit 4d, (v) a signal conversion IC 4e (which may also be referred to as a video data receiver, a video data receiver unit, an activating request receiver, or an activating request receiver unit), (vi) a display 4f (display unit), (vii) a backlight 4g, (viii) an IF unit 4h, and (ix) an indicator 4i. Further, the signal conversion IC 4e may function not only as a receiver receiving data but also as a transmitter transmitting data; namely the signal conversion IC 4e may function as a transceiver communicating data.

The controller 4a is mainly composed of the MPU, executes a control program, and controls the overall operation of the center display apparatus 4. The control program executed by the controller 4a includes a display program. The power supply circuit 4b supplies operating power to each functional block inside the center display apparatus 4. The communication IF unit 4c controls data communication with the display control ECU 2 via the data communication line 6. The switch IF unit 4d detects the on/off of the external switch 11 and outputs the detection result to the controller 4a. When the signal conversion IC 4e receives the video data transmitted from the display control ECU 2, the signal conversion IC 4e converts the received video data in accordance with the standard of the center display apparatus 4, and outputs the converted video data to the display 4f.

The display 4f is, for example, a TFT liquid crystal display, and when video data is received from the signal conversion IC 4e, the received video data is decoded and the video corresponding to the video data is displayed. The backlight 4g is turned on when a lighting on command is received from the controller 4a, and is turned off when a lighting off command is received from the controller 4a. When the IF unit 4h receives a display command from the controller 4a, the IF unit 4h displays the indicator 4i according to the received display command.

The first signal conversion IC 2f of the display control ECU 2 and the signal conversion IC 3e of the meter apparatus 3 are connected by a coaxial cable or a differential cable. The first signal conversion IC 2f of the display control ECU 2 converts video data, serial data (UART, I2C, SPI, etc.) and general-purpose output data into high-speed serial signals. The converted high-speed serial signal is transmitted to the signal conversion IC 3e of the meter apparatus 3. When the signal conversion IC 3e of the meter apparatus 3 receives a high-speed serial signal from the first signal conversion IC 2f of the display control ECU 2, the signal conversion IC 3e reconverts the received high-speed serial signal and separates the reconverted high-speed serial signal into video data, serial data, and general-purpose output data for output.

Further, the signal conversion IC 3e of the meter apparatus 3 converts the serial data and the general-purpose output data into a low-speed serial signal, and transmits the converted low-speed serial signal to the first signal conversion IC 2f of the display control ECU 2. When the first signal conversion IC 2f of the display control ECU 2 receives a low-speed serial signal from the signal conversion IC 3e of the meter apparatus 3, it reconverts the received low-speed serial signal and separates the reconverted low-speed serial signal into serial data and general-purpose output data for output.

The second signal conversion IC 2g of the display control ECU 2 and the signal conversion IC 4e of the center display apparatus 4 are also connected by a coaxial cable or a differential cable. The relation between the second signal conversion IC 2g and the signal conversion IC 4e is thus the same as the relation between the first signal conversion IC 2f of the display control ECU 2 and the signal conversion IC 3e of the meter apparatus 3.

The above configuration is a configuration in which the meter apparatus 3 and the center display apparatus 4 do not have a GDC (Graphic Display Controller) and the display of videos in the meter apparatus 3 and the center display apparatus 4 is controlled by the display control ECU 2. In such a configuration, as mentioned above, the following problems are assumed. That is, suppose a case where the display control ECU 2 and the meter apparatus 3 each start the activating process at the same time, and the activating time of the display control ECU 2 is longer than the activating time of the meter apparatus 3. Such a case produces a situation where the meter apparatus 3 can receive the video data from the display control ECU 2 to display the video, but the display control ECU 2 may not be able to transmit the video data to the meter apparatus 3. In that case, the meter apparatus 3 starts the display operation of the display 3f, but cannot receive the video data from the display control ECU 2. Therefore, the video cannot be displayed, which may give the user a sense of discomfort. In view of this point, the following configuration is adopted in the present embodiment. Hereinafter, the relation between the display control ECU 2 and the meter apparatus 3 will be described, but the same applies to the relation between the display control ECU 2 and the center display apparatus 4.

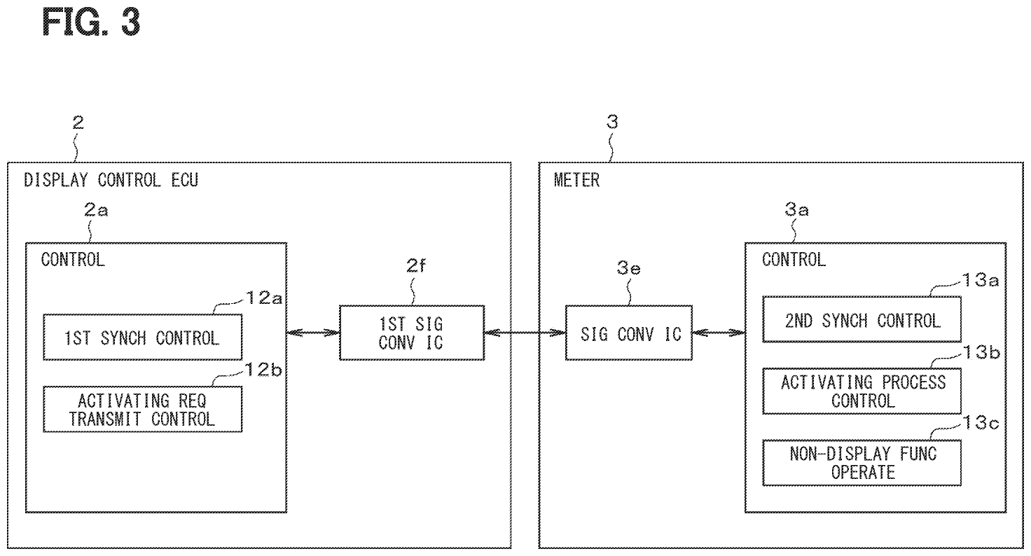

As shown in FIG. 3, in the display control ECU 2, the controller 2a includes a first synchronization controller unit 12a and an activating request transmission controller unit 12b. The first synchronization controller unit 12a synchronizes the transmission start timing to start the transmission of video data from the first signal conversion IC 2f to the meter apparatus 3 with the display operation start timing for the meter apparatus 3 to start the display operation of the display 3f, in response to the first signal conversion IC 2f receiving the activating process completion notification from the meter apparatus 3. When the activating factor occurs, the activating request transmission controller unit 12b causes the first signal conversion IC 2f to transmit the activating request to the meter apparatus 3.

In the meter apparatus 3, the controller 3a includes a second synchronization controller unit 13a, an activating process controller unit 13b, and a non-display function operation unit 13c. The second synchronization controller unit 13a synchronizes the display operation start timing to start the display operation of the display 3f with the transmission start timing for the display control ECU 2 to start the transmission of the video data, in response to the signal conversion IC 3e transmitting an activating process completion notification to the display control ECU 2. The activating process controller unit 13b starts the activating process when the activating request is received by the signal conversion IC 3e. The non-display function operating unit 13c activates a non-display function other than the function of displaying videos. The non-display functions other than the function of displaying videos include the pointer operations of the vehicle speed meter 8 and the tachometer 9, the lighting of the indicator 3k, the sounding of the speaker 3i, and the like.

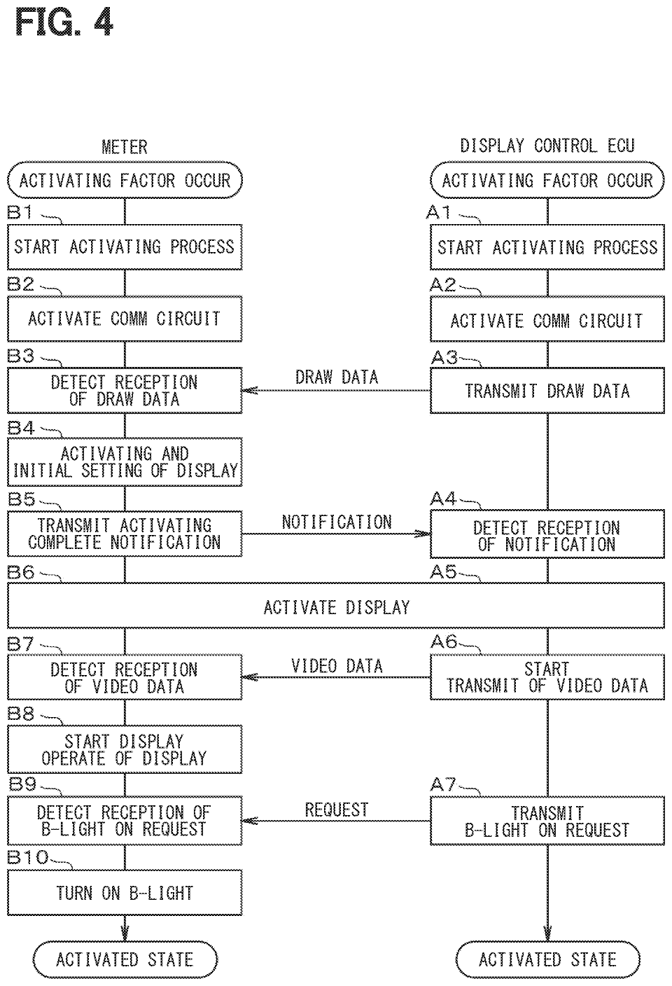

Next, the operation of the above configuration will be described with reference to FIGS. 4 to 7. The following will describe the process performed by the display control ECU 2 and the meter apparatus 3 when the activating factor occurs, and the process performed by the display control ECU 2 and the meter apparatus 3 when the sleep factor occurs.

(1) When Activating Factor Occurs

As the case where an activating factor occurs, the case where both the display control ECU 2 and the meter apparatus 3 detect the occurrence of the activating factor and the case where only the display control ECU 2 detects the occurrence of the activating factor will be described.

(1-1) When Both the Display Control ECU 2 and the Meter Apparatus 3 Detect an Occurrence of an Activating Factor

As shown in FIG. 4, in the display control ECU 2, the controller 2a detects an occurrence of an activating factor such as a door being opened under the state of monitoring an occurrence of the activating factor. Then, the activating process is started (A1), and the activating process of the communication circuit of the first signal conversion IC2f is started (A2). When the controller 2a completes the activating process of the communication circuit of the first signal conversion IC 2f, the controller 2a causes the first signal conversion IC 2f to transmit the drawing data to the meter apparatus 3 (A3). When the controller 2a transmits the drawing data from the first signal conversion IC 2f to the meter apparatus 3, the controller 2a waits for the reception of the activating process completion notification from the meter apparatus 3. The drawing data, unlike the video data, is data required for the meter apparatus 3 to perform the activating process and the initial setting of the display 3f.

In the meter apparatus 3, the controller 3a detects an occurrence of the activating factor under the state of monitoring an occurrence of the activating factor. Then, the activating process is started (B1), and the activating process of the communication circuit of the signal conversion IC 3e is started (B2). When the controller 3a completes the activating process of the communication circuit of the signal conversion IC 3e, the controller 3a waits for the reception of the drawing data from the display control ECU 2. When the controller 3a detects the reception of the drawing data from the display control ECU 2 by the signal conversion IC 3e (B3), the controller 3a starts the activating process and the initial setting of the display 3f (B4). The controller 3a then completes the activating process and the initial setting of the display 3f. Thereby, the signal conversion IC 3e transmits the activating process completion notification to the display control ECU 2 (B5), and the display activating process is started in cooperation with the display control ECU 2 (B6).

In the display control ECU 2, when the controller 2a detects the reception of the activating process completion notification from the meter apparatus 3 by the first signal conversion IC 2f (A4), the controller 2a starts the display activating process in cooperation with the meter apparatus 3 (A5). When the controller 2a completes the display activating process, the controller 2a starts transmitting video data from the first signal conversion IC 2f to the meter apparatus 3 (A6, first synchronization control procedure), transmits a backlight turning on request from the first signal conversion IC 2f to the meter apparatus 3 (A7), and shifts to the activated state.

In the meter apparatus 3, when the controller 3a detects the reception of video data from the display control ECU 2 by the signal conversion IC 3e (B7), the controller 3a starts the display operation of the display 3f (B8, the second synchronization control procedure). When the controller 3a detects the reception of the backlight turning on request from the display control ECU 2 by the signal conversion IC 3e (B9), the controller 3a turns on the backlight 3g (B10), and shifts to the activated state.

That is, in the above-mentioned series of processes, the meter apparatus 3 transmits the activating process completion notification to the display control ECU 2, and the display control ECU 2 receives the activating process completion notification from the meter apparatus 3. With a trigger event of the transmission and reception of an activating process completion notification by the meter apparatus 3 and the display control ECU 2, a configuration can be provided in which the transmission start timing for the display control ECU 2 to start transmitting video data to the meter apparatus 3 and the display operation start timing for the meter apparatus 3 to start the display operation of the display 3f are synchronized with each other.

(1-2) When Only the Display Control ECU 2 Detects an Occurrence of an Activating Factor

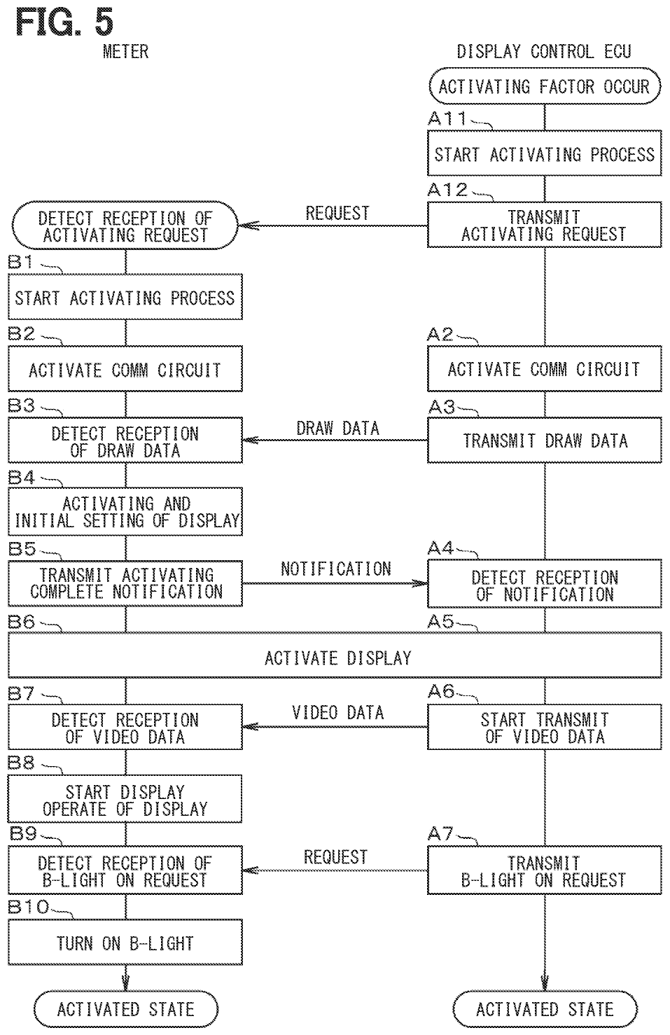

As shown in FIG. 5, in the display control ECU 2, when the controller 2a detects an occurrence of the activating factor under the state of monitoring the occurrence of the activating factor, the activating process is started (A11) and the activating request is transmitted from the signal conversion IC 2f to the meter apparatus 3 (A12). After the controller 2a transmits the activating request from the first signal conversion IC 2f to the meter apparatus 3, the controller 2a performs the above steps A2 to A7.

In the meter apparatus 3, after the controller 3a detects the reception of the activating request from the display control ECU 2 by the signal conversion IC 3e under the state of waiting for the reception of the activating request from the display control ECU 2, the controller 3a performs the above steps B1 to B10.

Even in this case, the meter apparatus 3 transmits the activating process completion notification to the display control ECU 2, and the display control ECU 2 receives the activating process completion notification from the meter apparatus 3. With a trigger event of the transmission and reception of an activating process completion notification by the meter apparatus 3 and the display control ECU 2, a configuration can be provided in which the transmission start timing for the display control ECU 2 to start transmitting video data to the meter apparatus 3 and the display operation start timing for the meter apparatus 3 to start the display operation of the display 3f are synchronized with each other.

(2) When Sleep Factor Occurs

A case where both the display control ECU 2 and the meter apparatus 3 detect an occurrence of the sleep factor and the case where only the display control ECU 2 detects an occurrence of the sleep factor will be described.

(2-1) When Both the Display Control ECU 2 and the Meter Apparatus 3 Detect an Occurrence of a Sleep Factor

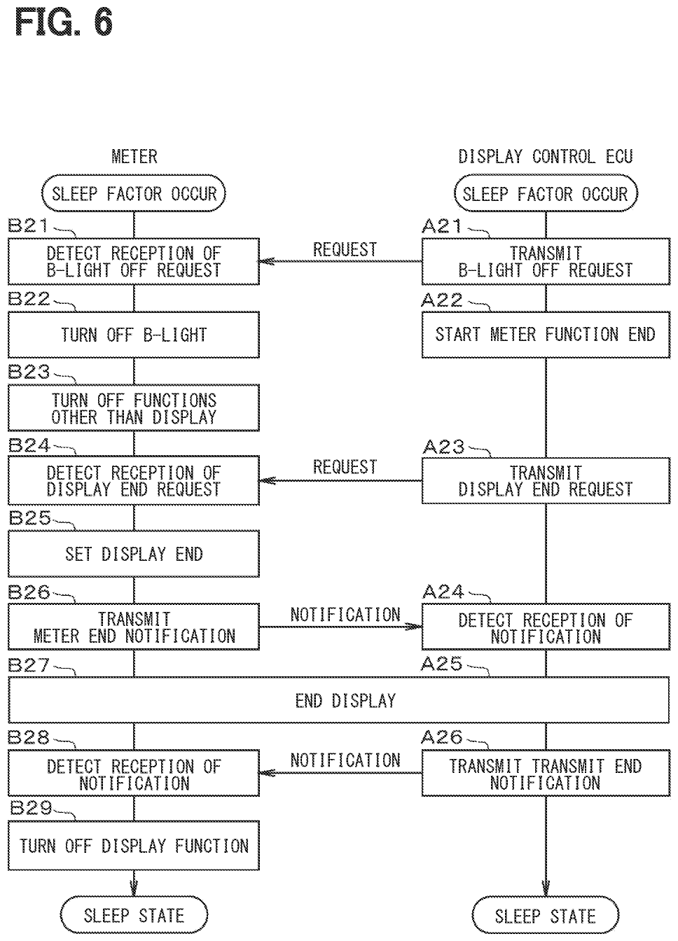

As shown in FIG. 6, in the display control ECU 2, when the controller 2a detects an occurrence of the sleep factor under the state of monitoring the occurrence of the sleep factor, the controller 2a transmits the backlight turning off request from the first signal conversion IC 2f to the meter apparatus 3 (A21). When the controller 2a transmits a backlight turning off request from the first signal conversion IC 2f to the meter apparatus 3, the controller 2a starts the meter function ending process (A22). When the controller 2a completes the meter function ending process, the controller 2a transmits the display ending process request from the first signal conversion IC 2f to the meter apparatus 3 (A23). When the controller 2a transmits the display ending process request from the first signal conversion IC 2f to the meter apparatus 3, the controller 2a waits for the reception of the meter apparatus end notification from the meter apparatus 3.

In the meter apparatus 3, when the controller 3a detects the occurrence of the sleep factor under the state of monitoring the occurrence of the sleep factor, the controller 3a waits for the reception of the backlight turning off request from the display control ECU 2. When the controller 3a detects the reception of the backlight turning off request from the display control ECU 2 by the signal conversion IC 3e (B21), the controller 3a turns off the backlight 3g (B22) and turns off the functions other than the function of displaying (B23). When the controller 3a detects the reception of the display ending process request from the display control ECU 2 by the signal conversion IC 3e (B24), the controller 3a sets the display end (B25), transmits the meter apparatus end notification from the signal conversion IC 3e to the display control ECU 2 (B26), and starts the display ending process in cooperation with the display control ECU 2 (B27).

In the display control ECU 2, when the controller 2a detects the reception of the meter apparatus end notification from the meter apparatus 3 by the first signal conversion IC 2f (A24), the controller 2a starts the display ending process in cooperation with the meter apparatus 3 (A25). When the controller 2a completes the display ending process, the controller 2a causes the first signal conversion IC 2f to transmit a transmission end notification indicating the end of transmission of video data from the first signal conversion IC 2f to the meter apparatus 3 (A26), and shifts to the sleep state.

In the meter apparatus 3, when the controller 3a detects the reception of the transmission end notification from the display control ECU 2 by the signal conversion IC 3e (B28), the controller 3a turns off the function of the display 3f (B29) and shifts to the sleep state.

(2-2) When Only the Display Control ECU 2 Detects an Occurrence of a Sleep Factor

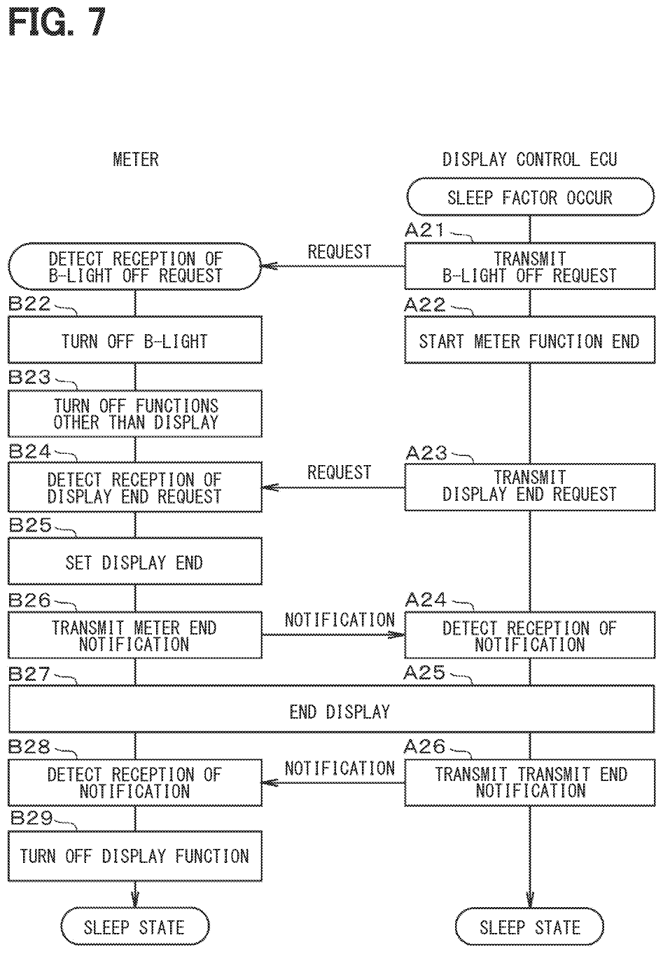

As shown in FIG. 7, in the display control ECU 2, when the controller 2a detects an occurrence of the sleep factor under the state of monitoring the occurrence of the sleep factor, the controller 2a transmits the backlight turning off request from the first signal conversion IC 2f to the meter apparatus 3 (A21). After the controller 2a transmits the backlight turning off request from the first signal conversion IC 2f to the meter apparatus 3, the controller 2a performs the above steps A22 to A26.

In the meter apparatus 3, when the controller 3a detects the reception of the backlight turning off request from the display control ECU 2 by the signal conversion IC 3e under the state of waiting for the reception of the backlight turning off request from the display control ECU 2, the controller 3a performs the above steps B22 to B29.

As described above, according to the first embodiment, the following effects can be obtained. In the display control system, the meter apparatus 3 transmits the activating process completion notification to the display control ECU 2, and the display control ECU 2 receives the activating process completion notification from the meter apparatus 3. With such a trigger event of the transmission and reception of an activating process completion notification by the meter apparatus 3 and the display control ECU 2, a configuration can be provided in which the transmission start timing for the display control ECU 2 to start transmitting video data to the meter apparatus 3 and the display operation start timing for the meter apparatus 3 to start the display operation of the display 3f are synchronized with each other.

Suppose a case where the activating time of the meter apparatus 3 and the activating time of the display control ECU 2 are different, and the meter apparatus 3 can receive video data from the display control ECU 2 to display the video. In such a case, there may be arising a situation in which the display control ECU 2 is not capable of transmitting video data to the meter apparatus 3. Even if the above situation arising, under the present embodiment, the meter apparatus 3 can be prevented from starting the display operation until the display control ECU 2 can transmit the video data to the meter apparatus 3. As a result, it is possible to avoid the occurrence of a situation in which the display operation of the display 3f is started under the state where the meter apparatus 3 has not received the video data from the display control ECU 2.

Further, when only the display control ECU 2 detects the occurrence of the activating factor, the meter apparatus 3 is configured to start the activating process in response to detecting the reception of the activating request from the display control ECU 2. Even in a configuration in which the meter apparatus 3 cannot detect the occurrence of an activating factor, the display control ECU 2 transmits an activating request to the meter apparatus 3. Thereby, the meter apparatus 3 can also start an activating process by following the display control ECU 2 starting the activating process. Further, when only the display control ECU 2 detects the occurrence of a sleep factor, the meter apparatus 3 is configured to shift to the sleep state in response to detecting the reception of the backlight turning off request from the display control ECU 2. Even in a configuration in which the meter apparatus 3 cannot detect the occurrence of a sleep factor, the display control ECU 2 transmits a backlight turning off request to the meter apparatus 3. Thereby, the meter apparatus 3 can shift to the sleep state by following the display control ECU 2 shifting to the sleep state.

### Second Embodiment

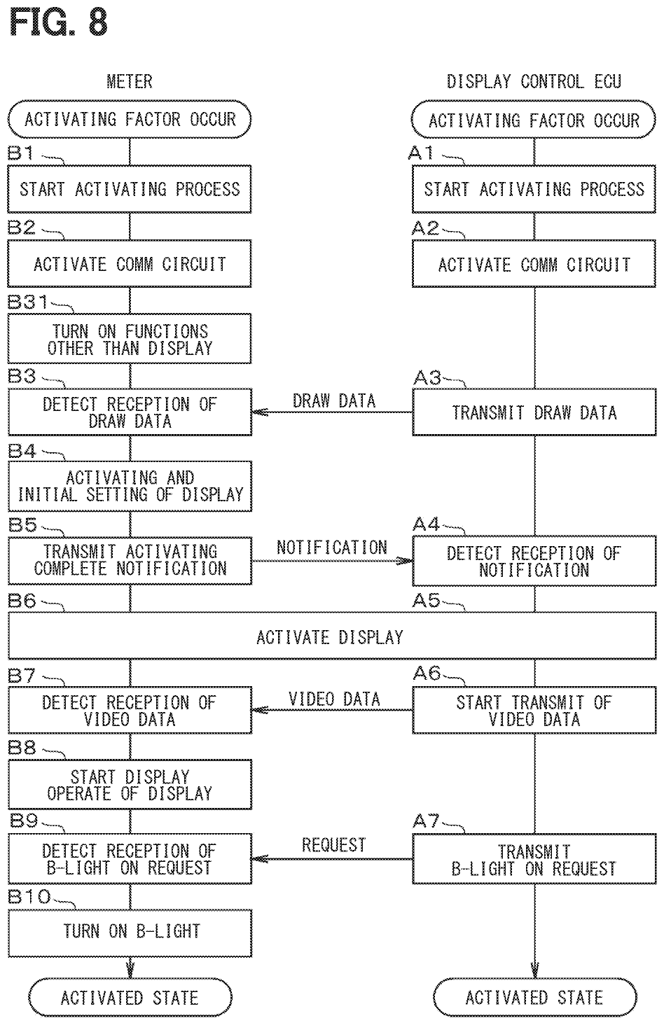

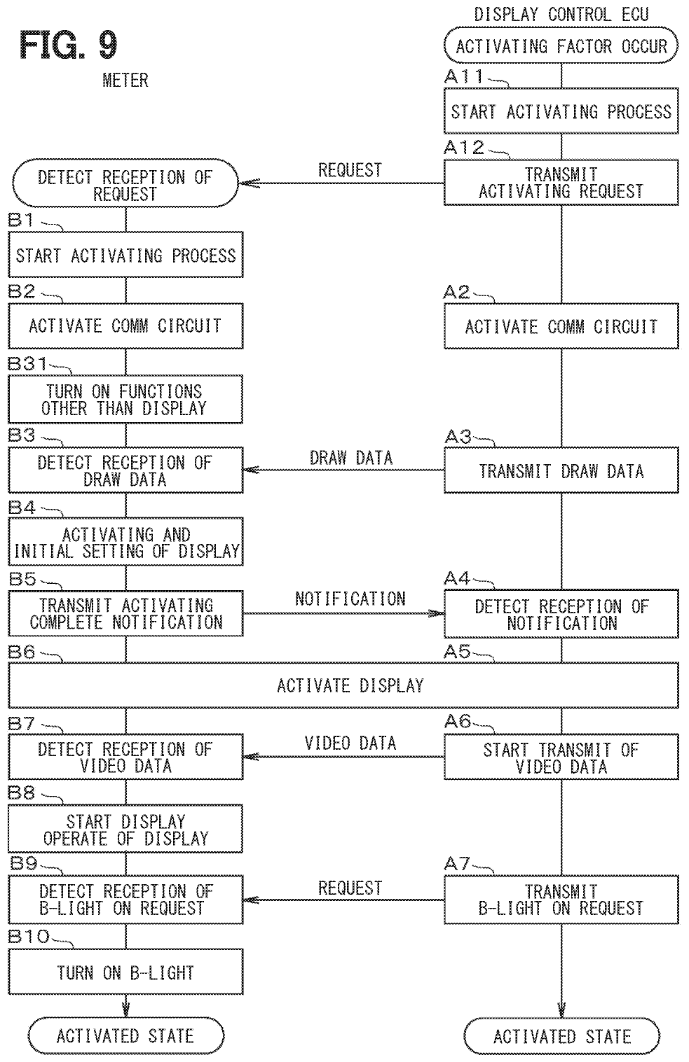

Next, the second embodiment will be described with reference to FIGS. 8 and 9. The same parts as those in the first embodiment described above will be omitted, and different parts will be described. In the second embodiment, in the meter apparatus 3, the operation process of the non-display function other than the function of displaying the video.

As shown in FIGS. 8 and 9, in the meter apparatus 3, when the controller 3a completes the activating process of the communication circuit of the signal conversion IC 3e, the controller 3a starts the operation process of the non-display function other than the function of displaying videos, so as to turn on the function other than the function of displaying the videos (B31). That is, the controller 3a activates functions such as pointer operation of the vehicle speed meter 8 and the tachometer 9, lighting of the indicator 3k, and sounding of the speaker 3i. When a function other than the function of displaying is turned on, the reception of drawing data from the display control ECU 2 is waited for.

As described above, according to the second embodiment, as in the first embodiment described above, the transmission start timing for the display control ECU 2 to start transmitting video data to the meter apparatus 3 and the display operation start timing for the meter apparatus 3 to start the display operation of the display 3f are synchronized with each other. Therefore, the same effect as that of the first embodiment can be obtained. Further, before starting the display operation of the display 3f, the operation process of the non-display function other than the function of displaying the videos is started, and the functions other than the function of displaying are turned on. It is possible to start the operation of the function that operates independently by the information from the vehicle side such as the pointer operation of the vehicle speed meter 8 and the tachometer 9, the lighting of the indicator 3k, and the sounding of the speaker 3i, regardless of the display operation of the display 3h. Functions related to legal matters can thus be activated immediately.

### Third Embodiment

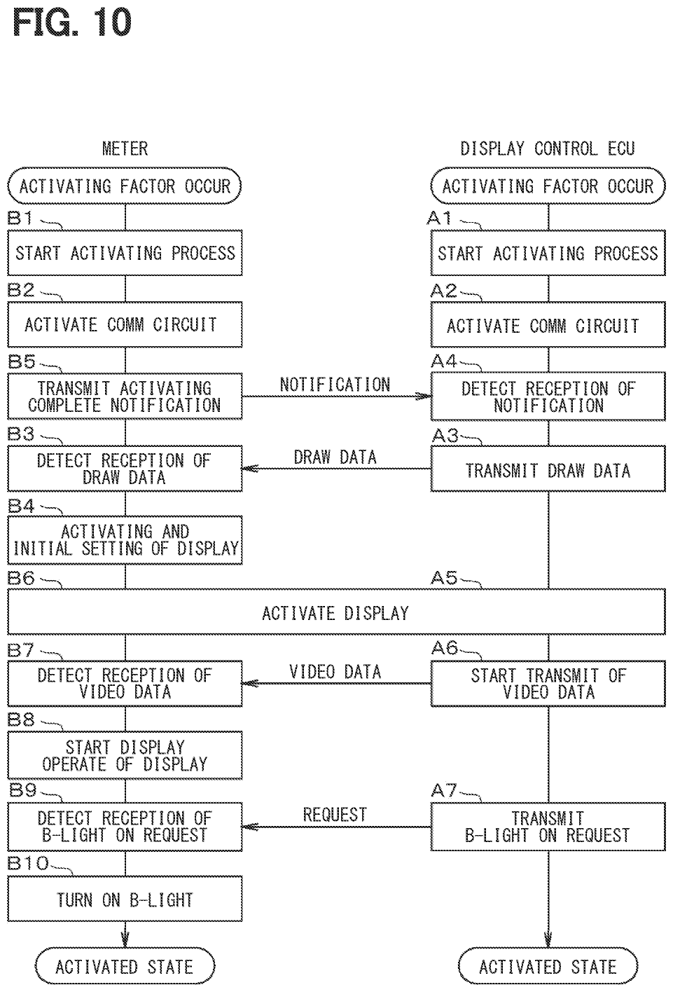

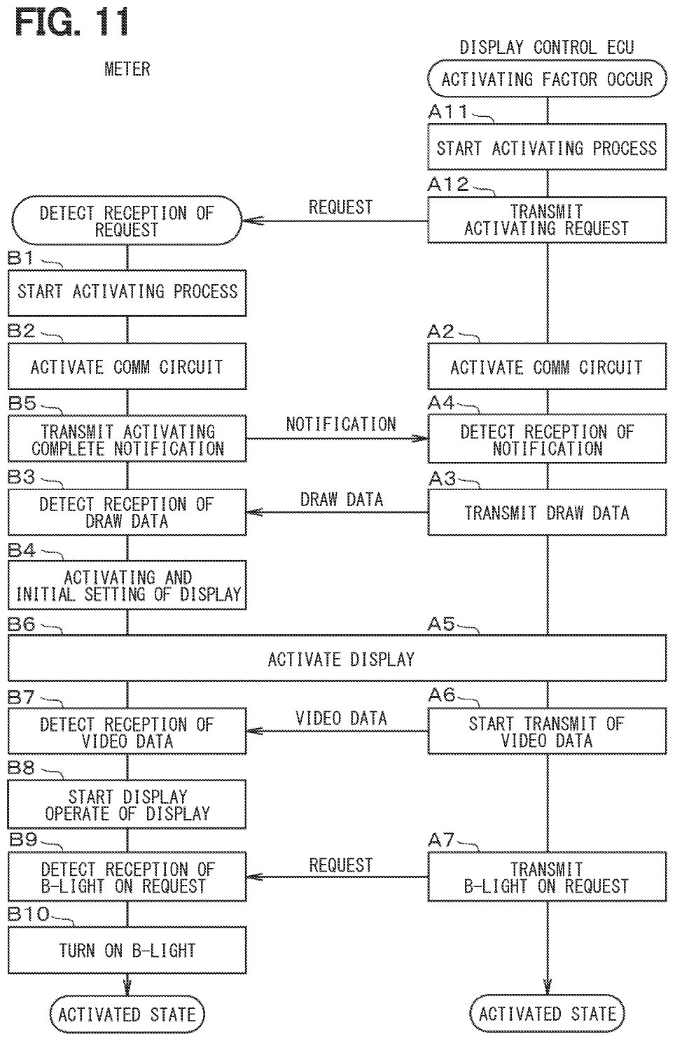

Next, the third embodiment will be described with reference to FIGS. 10 and 11. The same parts as those in the first embodiment described above will be omitted, and different parts will be described. In the third embodiment, in the meter apparatus 3, after transmitting the activating process completion notification to the display control ECU 2, the activating process and initial setting of the display 3f are performed.

As shown in FIGS. 10 and 11, when the display control ECU 2 completes the activating process of the communication circuit of the first signal conversion IC 2f, the controller 2a waits for the reception of the activating process completion notification from the meter apparatus 3.

In the meter apparatus 3, when the controller 3a completes the activating process of the communication circuit of the signal conversion IC 3e, the controller 3a causes the signal conversion IC 3e to transmit an activating process completion notification to the display control ECU 2 (B5), and waits for the reception of the drawing data from the display control ECU 2.

In the display control ECU 2, when the controller 2a detects the reception of the activating process completion notification from the meter apparatus 3 by the first signal conversion IC 2f (A4), the controller 2a transmits the drawing data from the first signal conversion IC 2f to the meter apparatus 3 (A3), and starts the display activating process in cooperation with the meter apparatus 3 (A5).

In the meter apparatus 3, when the controller 3a detects the reception of the drawing data from the display control ECU 2 by the signal conversion IC 3e (B3), the controller 3a starts the activating process and the initial setting of the display 3f (B4). When the controller 3a completes the activating process and the initial setting of the display 3f, the controller 3a starts the display activating process in cooperation with the display control ECU 2 (B6).

As described above, according to the third embodiment, similarly to the first embodiment described above, the transmission start timing for the display control ECU 2 to start transmitting video data to the meter apparatus 3 and the display operation start timing for the meter apparatus 3 to start the display operation of the display 3f are synchronized with each other. Therefore, the same effect as that of the first embodiment can be obtained.

### Fourth Embodiment

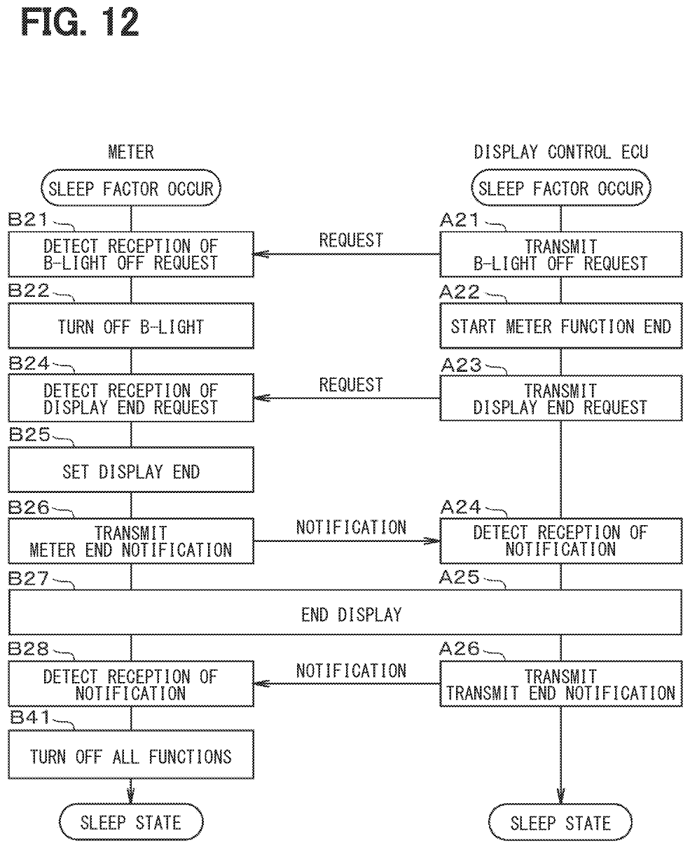

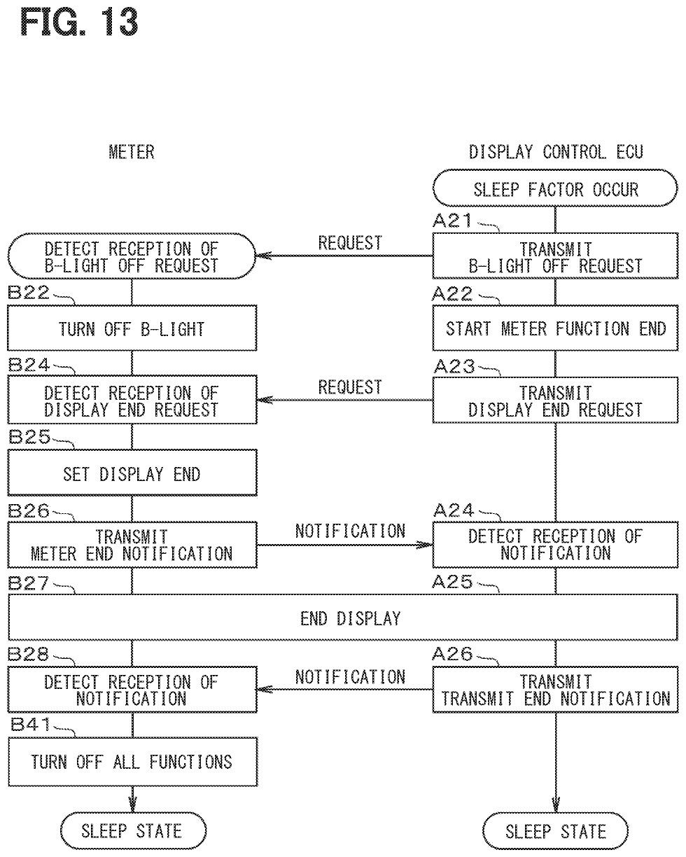

Next, a fourth embodiment will be described with reference to FIGS. 12 and 13. The same parts as those in the first embodiment described above will be omitted, and different parts will be described. In the fourth embodiment, when the meter apparatus 3 detects the reception of the transmission end notification from the display control ECU 2 by the signal conversion IC 3e, the meter apparatus 3 turns off all the functions.

As shown in FIGS. 12 and 13, in the meter apparatus 3, when the controller 3a detects the reception of the backlight turning off request from the display control ECU 2 by the signal conversion IC 3e (B21), the controller 3a turns off the backlight 3g (B22), and waits for the reception of the display ending process request from the display control ECU 2 while not turning off the functions other than the function of displaying. After that, when the controller 3a detects the reception of the transmission end notification from the display control ECU 2 by the signal conversion IC 3e (B28), the controller 3a turns off all the functions (B41) and shifts to the sleep state.

As described above, according to the fourth embodiment, similarly to the first embodiment described above, the transmission start timing for the display control ECU 2 to start transmitting video data to the meter apparatus 3 and the display operation start timing for the meter apparatus 3 to start the display operation of the display 3f are synchronized with each other. Therefore, the same effect as that of the first embodiment can be obtained. Also, at the same time as turning off the display function, the functions other than the function of displaying are turned off. As a result, it is possible to maintain a long period of time during which the functions other than the function of displaying are turned on.

### Other Embodiments

While the present disclosure has been described based on the embodiments, the present disclosure is not limited to the embodiments or structures described herein. The present disclosure incorporates various modifications and variations within the scope of equivalents. Additionally, various combinations and configurations, as well as other combinations and configurations including more, less, or only a single element, are within the scope and spirit of the present disclosure.

As the display 3f of the meter apparatus 3 and the display 4f of the center display apparatus 4, a TFT liquid crystal display that requires backlight 3g and 4g has been exemplified. However, an organic EL (Electro Luminescence) display that does not require backlight 3g or 4g may be adopted.

The controller, which may also be referred to as a controller circuit, such as the controller 2a, the controller 3a, the controller 4a, and methods thereof described in the present disclosure in the above embodiments may be implemented by one or more special-purpose computers. Such computers may be created (i) by configuring (a) a memory and a processor programmed to execute one or more particular functions embodied in computer programs, or (ii) by configuring (b) a processor provided by one or more special purpose hardware logic circuits, or (iii) by configuring a combination of (a) a memory and a processor programmed to execute one or more particular functions embodied in computer programs and (b) a processor provided by one or more special purpose hardware logic circuits. The computer program may be stored, as an instruction executed by a computer, in a computer-readable non-transitory tangible storage medium.

For reference to further explain features of the present disclosure, the description is added as follows.

There is known a display control system including (i) a display apparatus with a display and (ii) a display control apparatus for controlling a video displayed on the display in the display apparatus.

In this type of display control system, when video data is transmitted from the display control apparatus to the display apparatus, the video corresponding to the video data is displayed on the display apparatus. For example, if the display apparatus is an in-vehicle meter apparatus, video data is transmitted from the display control apparatus to the meter apparatus, so that, for example, videos such as the remaining amount of fuel and the mileage are displayed on the meter apparatus.

The display control apparatus and the display apparatus are different from each other in respect of the software configuration and hardware processing capacity. The activating time from when the display control apparatus starts the activating process to when the video data can be transmitted to the display apparatus is thus different from the activating time from when the display apparatus starts the activating process to when the video corresponding to the video data can be displayed. Suppose a case where when the display control apparatus and the display apparatus each start the activating process at the same time in response to an occurrence of an activating factor such as a door opening, the activating time of the display control apparatus is longer than the activating time of the display apparatus. Such a case may produce a situation where the display apparatus can receive the video data from the display control apparatus to display the video, but the display control apparatus may not be able to transmit the video data to the display apparatus. In this situation, the display apparatus starts the display operation of the display, but does not receive the video data from the display control apparatus. Therefore, there is a risk of giving the user a sense of discomfort.

It is thus desired to prevent an occurrence of a situation in which the display operation of the display starts under the state where the display apparatus has not receive video data from the display control apparatus, in a configuration where the activating time of the display apparatus and the activating time of the display control apparatus are different from each other.

Aspects of the present disclosure described herein are set forth in the following clauses.

According to an aspect of the present disclosure, a display control apparatus is provided to include a video data transmitter and a first synchronization controller unit. The video data transmitter is a transmitter configured to perform a transmission of a video data to a display apparatus. The first synchronization controller unit is configured to synchronize a transmission start timing to start the transmission of the video data from the video data transmitter to the display apparatus with a display operation start timing for the display apparatus to start a display operation in a display.

Under the above configuration, a transmission start timing to start the transmission of the video data from the video data transmitter to the display apparatus is synchronized with a display operation start timing for the display apparatus to start a display operation in a display. Suppose a case where the activating time of the display apparatus and the activating time of the display control apparatus are different, and the display apparatus can receive video data from the display control apparatus to display the video. In such a case, there may be arising a situation in which the display control apparatus is not capable of transmitting video data to the display apparatus. Even if the above situation arising, under the above configuration, the display apparatus can be prevented from starting the display operation until the display control apparatus can transmit the video data to the display apparatus. As a result, it is possible to avoid the occurrence of a situation in which the display operation of the display is started under the state where the display apparatus has not received the video data from the display control apparatus.

According to another aspect of the present disclosure, a display apparatus is provided to include a video data receiver, a display, and a second synchronization controller unit. The video data receiver is a receiver configured to receive video data from a display control apparatus. The display is configured to display a video corresponding to the video data received by the video data receiver. The second synchronization controller unit is configured to synchronize a display operation start timing to start a display operation in the display with a transmission start timing for the display control apparatus to start a transmission of the video data to the display apparatus.

Under the above configuration, a display operation start timing to start a display operation in the display is synchronized with a transmission start timing for the display control apparatus to start a transmission of the video data to the display apparatus. Suppose a case where the activating time of the display apparatus and the activating time of the display control apparatus are different, and the display apparatus can receive video data from the display control apparatus to display the video. In such a case, there may be arising a situation in which the display control apparatus is not capable of transmitting video data to the display apparatus. Even if the above situation arising, under the above configuration, the display apparatus can be prevented from starting the display operation until the display control apparatus can transmit the video data to the display apparatus.

According to yet another aspect of the present disclosure, a display control system is provided to include a display control apparatus, and a display apparatus. The display control apparatus is configured to transmit video data. The display apparatus includes a display configured to display a video corresponding to the video data received from the display control apparatus. Herein, a transmission start timing for the display control apparatus to start transmitting the video data to the display apparatus is synchronized with a display operation start timing for the display apparatus to start a display operation of the display.

Under the above configuration, a transmission start timing for the display control apparatus to start transmitting the video data to the display apparatus is synchronized with a display operation start timing for the display apparatus to start a display operation of the display. Suppose a case where the activating time of the display apparatus and the activating time of the display control apparatus are different, and the display apparatus can receive video data from the display control apparatus to display the video. In such a case, there may be arising a situation in which the display control apparatus is not capable of transmitting video data to the display apparatus. Even if the above situation arising, under the above configuration, the display apparatus can be prevented from starting the display operation until the display control apparatus can transmit the video data to the display apparatus.

What is claimed is:

1. A display control apparatus comprising:
a video data transmitter being a transmitter configured to transmit a video data to a display apparatus; and
a first synchronization controller unit configured to synchronize a transmission start timing for the video data transmitter to start transmitting the video data to the display apparatus with a display operation start timing for the display apparatus to start a display operation in a display,
wherein:
in response to receiving an activating process completion notification indicating a completion of an activating process and initial setting of the display from the display apparatus, the first synchronization controller unit is configured to synchronize the transmission start timing with the display operation start timing in the display apparatus.

2. The display control apparatus according to claim 1, further comprising:
an activating request transmitter being a transmitter configured to transmit an activating request to the display apparatus; and
an activating request transmission controller unit configured to cause the activating request transmitter to transmit the activating request to the display apparatus in response to an occurrence of an activating factor.

3. A display apparatus comprising:
a video data receiver being a receiver configured to receive a video data from a display control apparatus;
a display configured to display a video corresponding to the video data received by the video data receiver; and
a second synchronization controller unit configured to synchronize a display operation start timing for the display to start a display operation with a transmission start timing for the display control apparatus to start transmitting the video data to the display apparatus,
wherein:
in response to transmitting an activating process completion notification indicating a completion of an activating process and initial setting of the display to the display control apparatus, the second synchronization controller unit is configured to synchronize the display operation start timing with the transmission start timing in the display control apparatus.

4. The display apparatus according to claim 3, further comprising:
an activating request receiver being a receiver configured to receive an activating request from the display control apparatus; and
an activating process controller unit configured to start the activating process in response to the activating request receiver receiving the activating request.

5. The display apparatus according to claim 3, further comprising:
a non-display function operating unit configured to operate a non-display function other than a function of displaying the video,
wherein:
the second synchronization controller unit is further configured to set an operation timing for the non-display function operating unit to operate the non-display function before the display operation start timing.

6. A display control system comprising:
a display control apparatus configured to transmit a video data; and
a display apparatus including a display configured to display a video corresponding to the video data received from the display control apparatus,
wherein:
in response to the display control apparatus receiving an activating process completion notification indicating a completion of an activating process and initial setting of the display from the display apparatus, a transmission start timing for the display control apparatus to start transmitting the video data to the display apparatus is synchronized with a display operation start timing for the display apparatus to start a display operation of the display.

7. A non-transitory computer readable storage medium storing a display control computer program product to a controller in a display control apparatus configured to transmit a video data to a display apparatus, the display control computer program product comprising instructions configured to, when executed by at least one processor in the controller, cause the at least one processor to:
synchronize a transmission start timing to start transmitting the video data to the display apparatus with a display operation start timing for the display apparatus to start a display operation in a display, in response to receiving an activating process completion notification indicating a completion of an activating process and initial setting of the display from the display apparatus.

8. A non-transitory computer readable storage medium storing a display computer program product to a controller in a display apparatus configured to receive a video data from a display control apparatus, the display computer program product comprising instructions configured to, when executed by at least one processor in the controller, cause the at least one processor to:
synchronize a display operation start timing to start a display operation in a display in the display apparatus with a transmission start timing for the display control apparatus to start transmitting the video data to the display apparatus, in response to transmitting an activating process completion notification indicating a completion of an activating process and initial setting of the display to the display control apparatus.

9. The display control apparatus according to claim 1, further comprising:
a first controller communicably coupled to the video data transmitter, the first controller being configured to implement the first synchronization controller unit.

10. The display apparatus according to claim 3, further comprising:
a second controller communicably coupled to the video data receiver, the second controller being configured to implement the second synchronization controller unit.

11. The display control system according to claim 6, further comprising:
at least one controller provided to be included in the display control apparatus or the display apparatus, the at least one controller being configured to synchronize the transmission start timing in the display control apparatus with the display operation start timing in the display apparatus in response to the activating process completion notification indicating the completion of the activating process and initial setting of the display being transmitted by the display apparatus or received by the display control apparatus.
